(19) United States
(12) Patent Application Publication
(10) Pub. No.: US 2024/0291183 A1
(43) Pub. Date: Aug. 29, 2024

(54) ULTRASONICALLY WELDED PRESS-FIT PIN

(71) Applicants: George R. Woody, Clinton, AR (US); David L. Bogdanchik, Pasadena, CA (US)

(72) Inventors: George R. Woody, Clinton, AR (US); David L. Bogdanchik, Pasadena, CA (US)

(21) Appl. No.: 18/115,766

(22) Filed: Feb. 28, 2023

(51) Int. Cl. H01R 12/58

(52) U.S. Cl. CPC H01R 12/585

(57) ABSTRACT

An improved solderless press-fit pin design capable of robustly mounting power semiconductor devices to printed circuit boards using ultrasonic welding thereby increasing manufacturing efficiency and lowering manufacturing temperatures and thus reducing the associated thermal stress to which the adjacent circuitry is exposed.

### CROSS-REFERENCE TO RELATED APPLICATIONS

This application is a Non-Provisional Utility Patent application claims the priority date of U.S. Provisional Application No. 63/314,485, titled: “ULTRASONICALLY WELDED PIN WITH PRESSFIT OR SODLERABLE HEAD,” filed Feb. 28, 2022, the disclosures of both are hereby incorporated by reference in its entirety.

### FIELD OF THE PRESENT DISCLOSURE

This disclosure relates generally to efficient semiconductor manufacturing technology and more specifically to an improved ultrasonically welded press-fit pin design capable of robustly mounting power semiconductor devices to printed circuit boards with increased efficiency and lower temperatures thereby reducing the overall associated thermal stress to which the adjacent circuitry is exposed.

### BACKGROUND OF THE RELATED ART

The field of semiconductor design and manufacturing is continuously becoming more efficient and cost effective. One such improvement in efficiency is achieved through the use of press-fit pins to connect various power semiconductor devices to printed circuit boards and/or to connect printed circuit boards to other printed circuit boards. Press-fit pins are designed to provide both the electrical contact to complete the intended electrical circuit and to provide the structural support required to physically hold the power semiconductor devices to printed circuit boards, and/or to hold the two or more circuit boards together.

This dual-purpose connection is accomplished simply by aligning the press-fit pins of the power semiconductor device with the through-hole vias of the intended printed circuit board, or vice versa, and inserting such pins into the through-hole vias. In order to establish both a robust electrical connection and sufficient structural support, the fit between the press-fit pins and the through-hole vias must be sufficiently tight. Sufficient tightness is ensured by the press-fit feature of the pin which is a feature with an increased cross-sectional dimension that exceeds the inner diameter of the through-hole via for which it is intended. The press-fit feature is also designed to elastically deform with relative ease such that when the pin is inserted into the through-hole via, the press-fit feature is forced to elastically deform but does not plastically deform. The press-fit feature's resilient tendency to elastically return its original, uncompressed shape creates sufficient force between the pin and the inner wall of the through-hole via to establish the desired robust electrical connection and the sufficient structural support for the junction.

The primary advantage of the press-fit pin technology lies in the improved efficiency of semiconductor manufacturing because assembly involves simply plugging power semiconductor devices into printed circuit boards without the typical time-consuming steps of soldering and then reflowing the resultant assembly. This process also makes power semiconductor device decoupling and/or replacement much more convenient. Further advantages include a reduced chance of experiencing circuitry damage due to the thermal stress on circuitry typically associated with the steps of soldering and reflow, and even the potential environmental advantages of using less solder, whether lead-based or not.

However, there is still room for further improvements of the press-fit pin technology as it stands today because most press-fit pins are still affixed at the non-press fit end using the standard soldering and reflow process. One common method of mounting the non-press-fit end of a press-fit pin includes the use of a base sleeve that is soldered on to the power semiconductor device and is designed to accept the non-press-fit end of the press-fit pin by means of a standard interference fit. Unlike the press-fit feature which is designed to elastically deform with ease thereby minimizing the force required to connect and disconnect the press-fit pin, the interference fit between the non-press-fit end of the press-fit pin and the base sleeve requires considerable force to joint and is designed to be a semi-permanent junction.

However, most importantly, the use of a soldered base sleeve to mount a non-press-fit end of the press-fit pin means that the manufacturing process must still include a soldering step and reflow step; therefore, the circuitry within the power semiconductor device must still endure the associated thermal stress. There exists a need for a press-fit pin that can be mounted by the non-press-fit end using lower temperature and more efficient technologies in comparison to the legacy soldering and reflow method.

The present disclosure distinguishes over the related art providing heretofore unknown advantages as described in the following summary.

### BRIEF SUMMARY OF THE INVENTION

The present disclosure describes a novel and innovative press-fit pin apparatus capable of being ultrasonically welded directly to direct bond copper substrate or active metal brazed substrate or other such metal substrate without the need for solder. The apparatus comprises an electrically conductive pin shaft that features a base plate and alignment feature on one terminal end and a press-fit feature located at or near the opposing terminal end.

The base plate, which can be any shape such as round, rectangular, or asymmetric, is oriented in a plane orthogonal to the axis of the pin shaft and affixed to its terminal end. The purpose of the base plate is to provide the bonding surface across which the ultrasonic weld occurs.

At or near the opposing terminal end of the pin shaft exists the press-fit feature. As with legacy press-fit pins, the press-fit feature is designed to exceed the diameter of the through-hole via for which it is intended but be capable of elastically deforming easily upon insertion. This can be achieved a number of ways including by exhibiting a hole in the middle of the pin shaft much like the eye of a needle which can elastically collapse upon insertion, or by a stamped deformation in the pin shaft creating and indention and an expanded zone of displaced material that can similarly deform plastically with relative relatively ease to accommodate the diameter of the through-hole via. Regardless of the particular embodiment design, the purpose and function of the press-fit feature is the same as it serves in legacy press-fit pins, namely, to create a robust electrical contact and to provide sufficient support for the attached power semiconductor device.

The alignment feature is critical to the success of the ultrasonic weld. Generally speaking, ultrasonic welding works by directing high frequency energy (approx. 20-40 kHz) at low amplitude (approx. 1-25 microns) to a focused location which creates mechanical vibrations which, when focused, will result in the generation of enough heat to melt the dissimilar metals and create a bond. When ultrasonically bonding a press-fit pin, the energy is directed and focused to the base plate by the ultrasonic capillary tool which must be shaped to complement the shape and size of the press-fit pin. The alignment feature couples closely with the ultrasonic capillary tool immediately adjacent to the base plate to ensure the energy being delivered through the ultrasonic capillary tool is transferred to the bonding site with minimal dissipation.

The alignment feature can take on several embodiments including, but not limited to, a chamfer, cone, or increase in the pin shaft diameter so long as the alignment feature couples closely with the ultrasonic capillary tool and located as close to the bonding location as possible so that the maximum possible portion of the sonic energy is successfully transferred and focused on the bonding site.

While the presently disclosed novel press-fit pin apparatus is designed to eliminate the time consuming and heat intensive steps of soldering and reflow during semiconductor manufacturing, it is possible to utilize this apparatus in a hybrid manner if it benefits the particular application, more specifically, this novel press-fit pin can be ultrasonically welded at is base terminal end and soldered at its press-fit terminal end for a more permanent construction. Still further, the base plate designed for ultrasonic welding can be used as surface for soldering or reinforcing an ultrasonic weld bond with solder.

This disclosure teaches certain benefits in construction and use which give rise to the objectives described below.

A primary objective inherent in the above-described apparatus is to provide advantages not taught by the prior art.

Another objective is to provide an ultrasonically welded press-fit pin apparatus designed to increase semiconductor manufacturing efficiency.

A further objective is to provide an ultrasonically welded press-fit pin apparatus designed to decrease semiconductor manufacturing temperatures.

A still further objective is to provide an ultrasonically welded press-fit pin apparatus designed to decrease the thermal stress to which the surrounding circuitry is exposed during manufacturing.

Other features and advantages of the present invention will become apparent from the following more detailed description, taken in conjunction with the accompanying drawings, which illustrate, by way of example, the principles and features of the presently described apparatus.

### BRIEF DESCRIPTION OF THE SEVERAL VIEWS OF THE DRAWING(S)

The accompanying drawings illustrate various exemplary implementations and are part of the specification. The illustrated implementations are proffered for purposes of example, not for purposes of limitation. Illustrated elements will be designated by numbers. Once designated, an element will be identified by the identical number throughout. Illustrated in the accompanying drawing(s) is at least one of the best mode embodiments of the present disclosure. In such drawing(s):

FIG. 1 is a perspective view of an exemplar embodiment of the presently disclosed novel press-fit pin apparatus illustrated with a circular base, a rectangular shaft cross-section, and a chamfer alignment feature adjacent to the base for coupling with the ultrasonic capillary tool.

FIG. 2 is a cutaway plan view of the presently disclosed novel press-fit pin apparatus illustrated in FIG. 1 shown coupled with the ultrasonic capillary tool.

FIG. 3 is a perspective view of the presently disclosed novel press-fit pin apparatus illustrated with a circular base, a circular shaft cross-section, and a cone-shaped alignment feature adjacent to the base for coupling with the ultrasonic capillary tool.

FIG. 4 is a cutaway plan view of the presently disclosed novel press-fit pin apparatus illustrated in FIG. 3 shown coupled with the ultrasonic capillary tool.

FIG. 5 is a perspective view of the presently disclosed novel press-fit pin apparatus illustrated with a circular base, a rectangular shaft cross-section, and a stamp indention alignment feature adjacent to the base for coupling with the ultrasonic capillary tool.

FIG. 6 is a cutaway plan view of the presently disclosed novel press-fit pin apparatus illustrated in FIG. 5 shown coupled with the ultrasonic capillary tool.

FIG. 7 is a perspective view of the presently disclosed novel press-fit pin apparatus illustrated with a circular base, a circular shaft cross-section, and a larger circular shaft circumference alignment feature adjacent to the base for coupling with the ultrasonic capillary tool.

FIG. 8 is a cutaway plan view of the presently disclosed novel press-fit pin apparatus illustrated in FIG. 7 shown coupled with the ultrasonic capillary tool.

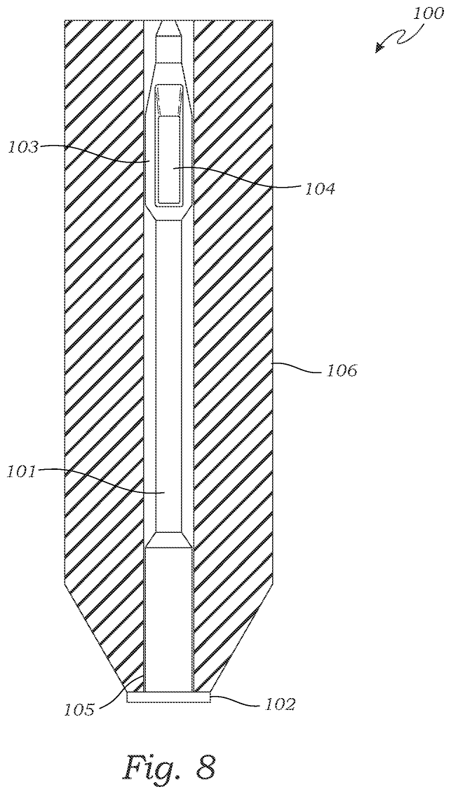

### DETAILED DESCRIPTION OF THE EXEMPLARY EMBODIMENT

The above-described drawing figures illustrate an exemplary embodiment of presently disclosed apparatus and its many features in at least one of its preferred, best mode embodiments, which is further defined in detail in the following description. Those having ordinary skill in the art may be able to make alterations and modifications to what is described herein without departing from its spirit and scope of the disclosure. Therefore, it must be understood that what is illustrated is set forth only for the purposes of example and that it should not be taken as a limitation in the scope of the present apparatus or its many features.

Described now in detail are a series of drawings depicting various features and details for the purpose of further clarifying the presently disclosed apparatus and method.

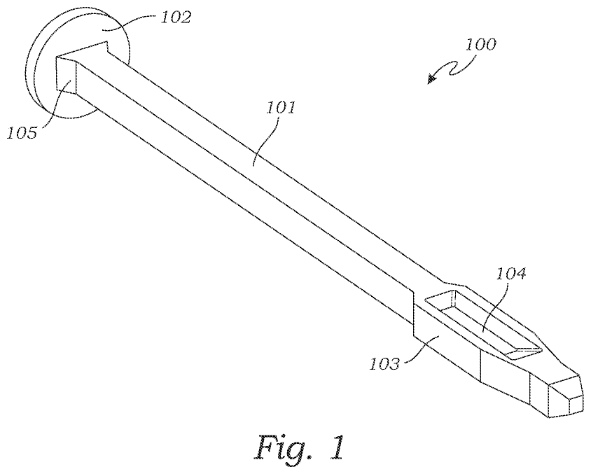

FIG. 1 is a perspective view of an exemplary embodiment of the presently disclosed novel press-fit pin apparatus 100 featuring a square or rectangular pin shaft 101 with a circular base 102 affixed at one terminal end of the pin shaft 101, existing in an orthogonal plane with respect to the axis of the pin shaft 101. On the opposing terminal end of the pin shaft 101 there exist a press-fit feature 103, 104 comprised of a stamped indention 104 and an expanded area 103 formed by the displaced material from the stamped indention 104.

As previously described, this press-fit feature 103, 104 is designed to have greater cross-sectional dimension than the diameter of the through-hole via for which it is intended. When inserted in the through-hole via, the expanded area 103 can elastically deform to fit within the smaller through-hole via with relative ease forming a connection with enough structural integrity to support the attached semiconductor devices and yet be capable to decoupling if necessary.

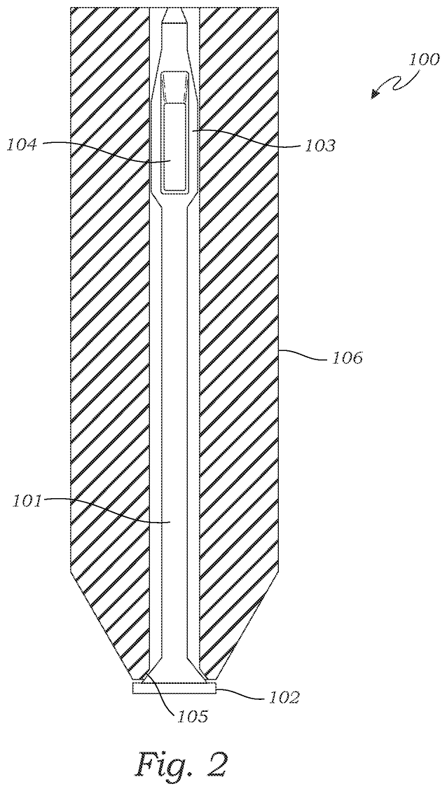

FIG. 2 is a cutaway plan view of the exemplar embodiment of the presently disclosed apparatus 100 shown in FIG. 1 illustrated inside the ultrasonic capillary tool capillary 106. The novel press-fit pin apparatus 100 must be fully inserted inside the ultrasonic capillary tool 106 during the ultrasonic welding process so that the ultrasonic capillary tool 106 can transfer sufficient sonic energy the base plate 102 to form a bond with whatever metal substrate to which the press-fit pin apparatus 100 is being bonded. The key feature of this exemplar embodiment 100 is that the alignment feature 105, in the form of a chamfer, located close to the base plate 102 and perfectly complementing the internal shape of the ultrasonic capillary tool 106 in order to maximize the transfer of energy.

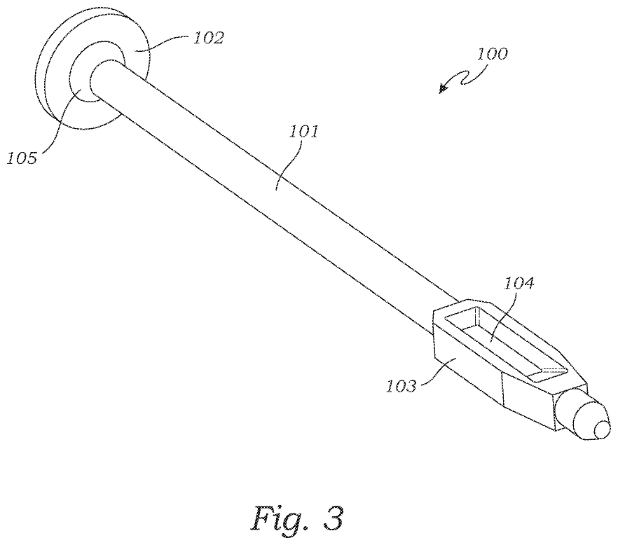

FIG. 3 is a perspective view of another exemplary embodiment of the presently disclosed novel press-fit pin apparatus 100. This embodiment 100 features a pin shaft 101 with a circular cross section, a similar press-fit feature 103, 104 created by a stamped indention 104, and a rounded alignment feature 105 located between the junction of the pin shaft 101 and the baseplate 102.

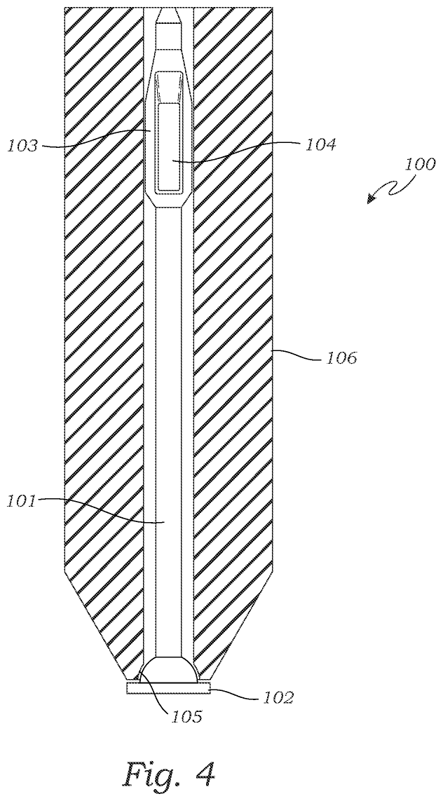

FIG. 4 illustrates the exemplar embodiment illustrated in FIG. 3 fully inserted in the ultrasonic capillary tool 106, which, as with previous embodiments, perfectly complements the shape of the alignment feature 105.

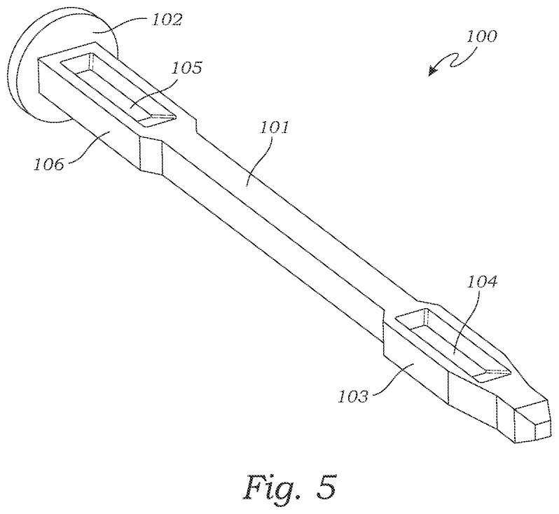

FIG. 5 is a perspective view of another exemplary embodiment of the presently disclosed novel press-fit pin apparatus 100. This embodiment uses a stamped indention 105 identical to the press-fit feature 103, 104 as the alignment feature 105.

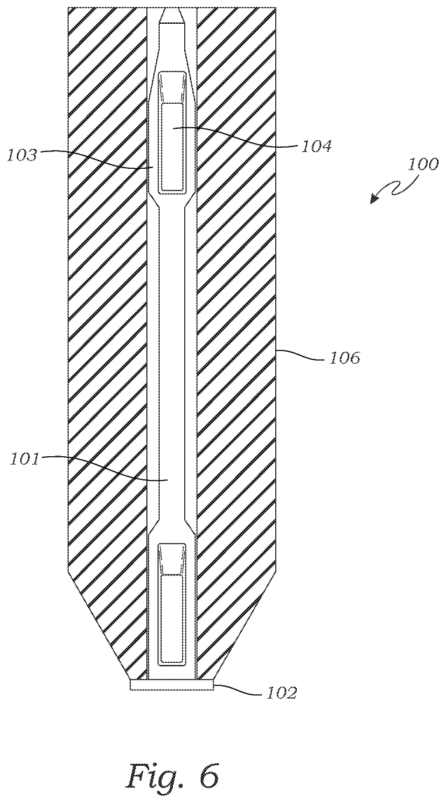

FIG. 6 is a cutaway plan view of the embodiment 100 illustrated in FIG. 5 shown fully inserted in the ultrasonic capillary tool 106. Once again, as with other embodiments 100, the internal shape of the ultrasonic capillary tool 106 closely compliments the shape of the alignment feature 105.

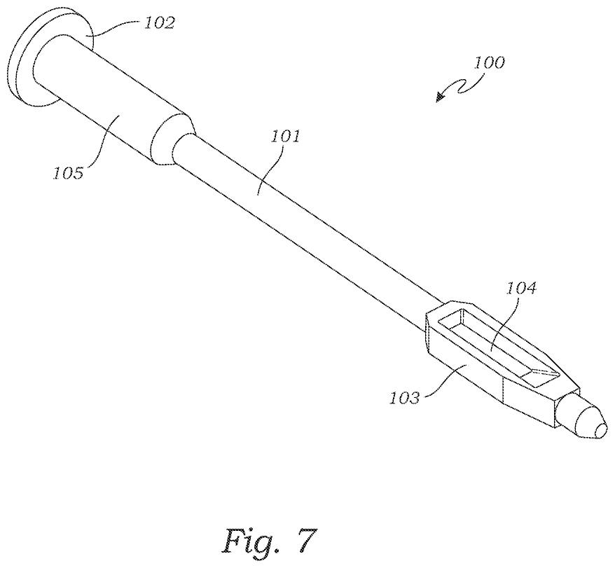

FIG. 7 is a perspective view of a fourth and final exemplar embodiment of the presently disclosed novel press-fit pin apparatus 100. In this embodiment 100, the pin shaft 101 exhibits a circular cross-section and the alignment tool 105 does as well, but of a greater diameter.

And, finally, Exhibit 8 is a cutaway plan view of the embodiment 100 illustrated in FIG. 7 fully inserted in the ultrasonic capillary tool 106, and as with previous embodiments 100, once again, the ultrasonic capillary tool is shaped to closely compliment the alignment feature 105, thereby ensuring the efficient transfer of sonic energy.

The enablements described in detail above are considered novel over the prior art of record and are considered critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed:

1. An improved press-fit semiconductor connector pin apparatus, said apparatus comprising:
a electrically conductive member having a first and second terminal end;
a electrically conductive plate affixed to the first terminal end of said electrically conductive member such that said electrically conductive plate exists in a plane orthogonal to the axis of said electrically conductive member;
a press-fit feature on said electrically conductive member located at or near the second terminal end of said electrically conductive member;
an alignment feature on the electrically conductive member at or near the first terminal end of said electrically conductive member.
